(19) United States
(12) Patent Application Publication
(10) Pub. No.: US 2014/0282533 A1
(43) Pub. Date: Sep. 18, 2014

(54) VIRTUAL COMPUTER SYSTEM

(71) Applicant: Mitsubishi Electric Corporation, Chiyoda-ku (JP)

(72) Inventor: Takayuki ITO, Chiyoda-ku (JP)

(73) Assignee: Mitsubishi Electric Corporation, Chiyoda-ku (JP)

(21) Appl. No.: 14/134,399

(22) Filed: Dec. 19, 2013

(30) Foreign Application Priority Data
Mar. 12, 2013 (JP) 2013-048686

(51) Int. Cl. G06F 9/455

(52) U.S. Cl. CPC G06F 9/4555
USPC 718/1

(57) ABSTRACT

When changing the speed of the progression of a logical time in a paravirtualized OS, a hypervisor updates reference time and a reference counter value which is the value of a counter when the reference time is updated, to be used for time calculation by the paravirtualized OS, in accordance with the changed speed of the progression of time, to have new reference time and a new reference counter value. After that, the paravirtualized OS calculates the present time based on the new reference time and the new reference counter value. This can serve to maintain the continuity of time in the paravirtualized OS through before and after a change in the speed of the progression of time if made in the progression of time.

### CROSS-REFERENCE TO RELATED APPLICATIONS

This application is based on and claims the benefit of priority from Japanese Patent Application No. 2013-048686, filed in Japan on Mar. 12, 2013, the content of which is incorporated herein by reference in its entirety.

### TECHNICAL FIELD

The present invention relates to a technology to manage the progression of time in a logical time whose progression speed of time is different from the progression speed of time of the actual time.

### BACKGROUND ART

A method has been proposed in which the progression of time in a computer is accelerated to outpace the progression of time in the actual time and thereby complete an experiment in several days when it takes a whole month in the actual time to be completed, for example.

In a conventional system for controlling the progression of time, an acceleration coefficient is used to shorten a timer interruption interval between an operating system (OS) and a timer, time is adjusted according to the acceleration coefficient, and the speed of the progression of time is accelerated (see e.g., Patent Documents 1 and 2).

In another conventional method, a plurality of software platforms are operated on a single computer, and the speed of the progression of time is accelerated on each of the software platform (see e.g., Patent Document 3).

Furthermore, as a CPU (central processing unit) equipped with a function to support the implementation of a virtual computer, Intel (trademark) IA-32 CPU is available, for example. A timer interrupt function to individual physical CPUs (see Non-Patent Document 1), a free-running counter function (see Non-Patent Document 2), and a virtualization support function (see Non-Patent Document 3) are also available.

When time in an OS is calculated based on the timer interruption interval, the degree of time granularity cannot be finer than the timer cycle interval.

For example, when time is calculated based on the number of times of timer interrupts in a cycle of 10 milliseconds, millisecond-scale time shorter than 10 milliseconds cannot be calculated.

Alternatively, time is calculated based on the counting up cycle of a free-running counter which counts up in a cycle shorter than a timer interruption cycle, like a CPU core-clock cycle, for example.

The speed of time can be accelerated by changing parameters used in calculating the time based on the counting up cycle of the free-running counter.

In virtualization in which the hardware of a computer is fully emulated (Full Virtualization), a hypervisor (referred to also as virtual computer monitor) shortens a timer interruption period which has been set through timer emulation, according to a time acceleration rate, and issues an interrupt to a virtual computer. Alternatively, an increased value of the free-running counter according to the acceleration rate is returned.

### CITATION LIST

### Patent Literature

Patent Document 1: JP 1-309136 A
Patent Document 2: JP 2004-38350 A
Patent Document 3: JP 9-171458 A

### Non-Patent Literature

Non-Patent Document 1: “Intel (trademark) 7 Series/C216 Chipset Family Platform Controller Hub (PCH) Datasheet”, Intel (registered trademark) Corporation, Order Number: 326776-003, June 2012, “5.7 8254 Timers”
Non-Patent Document 2: “Intel (registered trademark) 64 and IA-32 Architectures Software Developer's Manual”, “Volume 3 (3A, 3B & 3C): System Programming Guide”, Intel (registered trademark) Corporation, Order Number: 325384-044US, August 2012, “17.13 TIME-STAMP COUNTER”, Order Number: 325384-044US
Non-Patent Document 3: “Intel (registered trademark) 64 and IA-32 Architectures Software Developer's Manual”, “Volume 3 (3A, 3B & 3C): System Programming Guide”, Intel (registered trademark) Corporation, Order Number: 325384-044US, August 2012, “CHAPTER 24 VIRTUAL-MACHINE CONTROL STRUCTURES”, Order Number: 325384-044US

### SUMMARY OF INVENTION

### Technical Problem

Machine virtualization includes a full virtualization system in which a hardware (H/W) operation is fully emulated, and a paravirtualization system in which a suitable modification for virtualization is made to a guest OS in order to reduce emulation overheads.

In time-related H/W virtualization, a free-running counter and a timer are paravirtualized.

In timer paravirtualization, the hardware itself of a timer is not emulated, but a setting is made to the hypervisor so that the hypervisor calls back a function of a guest OS after a lapse of set time, and a process to be performed upon generation of a timer interrupt is executed in the callback function.

For the free-running timer, the guest OS calculates time based on data read out from a physical free-running counter and data transmitted from the hypervisor.

The data transmitted from the hypervisor is composed of a parameter for converting a value of the physical free-running counter into time, a free-running counter value as a reference for the calculation of time based on the free-running counter, and a parameter of the time corresponding to the free-running counter value.

Where a result from such a time calculation based on a free-running counter value is paravirtualized, however, it is required to change a parameter for converting the value of the free-running counter into time, in order that the speed of the progression of time in the guest OS may be accelerated in the hypervisor.

Simply changing the parameter alone, however, poses a problem causing discontinuity in time in the guest OS, between a time point right before the change and a time point right after the change, when the time acceleration rate is changed in the progression of time.

The present invention is directed mainly to solving problems such as that described above. A main objective is to maintain the continuity of time in a paravirtualized OS through before and after a change in the speed of progression of the time if made in the progression of time.

### Solution to Problem

A virtual computer system based on a paravirtualization method, according to the present invention includes:

a paravirtualized OS (operating system) which has been paravirtualized;

a hypervisor, and

hardware resources including:
a CPU (central processing unit) for executing the paravirtualized OS and the hypervisor;
a storage unit; and
a free-running counter for updating a counter value based on an operation clock cycle of the CPU,

wherein:

the hypervisor is executed by the CPU to:
specify reference time in an actual time, as reference time, to be used for calculating time in a logical time based on the counter value, the logical time having a different speed in the progression of time from the actual time;
specify a reference counter value, which is the counter value at the moment when the reference time is specified; and
specify a coefficient value for calculating the time in the logical time, based on the counter value;

the storage unit stores the reference time, the reference counter value, and the coefficient value: and the paravirtualized OS is executed by the CPU to:
read out the reference time, the reference counter value, and the coefficient value from the storage unit;
read out a current counter value from the free-running counter; and
calculate present time in the logical time based on the reference time, the reference counter value, the coefficient value, and the current counter value; and

the hypervisor, when the virtual computer system has received a change request requesting a change in the coefficient value:
reads out the reference time, the reference counter value, and the coefficient value from the storage unit;
reads out the current counter value from the free-running counter;
subtracts the reference counter value from the current counter value, multiplies a resultant subtraction value by the coefficient value before the change, adds a resultant product to the reference time, and specifies a resultant addition value as new reference time,
specifies the current counter value as new reference counter value; and
specifies a changed coefficient value as a new coefficient value;

the storage unit stores the new reference time, the new reference counter value, and the new coefficient value; and

the paravirtualized OS, after the virtual computer system has received the change request of the coefficient value:
reads out the new reference time, the new reference counter value, and the new coefficient value from the storage unit;
reads out the current counter value from the free-running counter; and
calculates the present time in the logical time based on the new reference time, the new reference counter value, the new coefficient value, and the current counter value.

### Advantageous Effects of Invention

According to the present invention, when changing the speed of the progression of a logical time in a paravirtualized OS, a hypervisor updates reference time and a reference counter value which is the value of a free-running counter, to be used for time calculation by the paravirtualized OS, in accordance with the changed speed of the progression of time, to have new reference time and a new reference counter value. After that, the paravirtualized OS calculates the present time based on the new reference time and the new reference counter value.

This can serve to maintain the continuity of time in the paravirtualized OS through before and after a change in the speed of the progression of time if made in the progression of time.

### BRIEF DESCRIPTION OF DRAWINGS

The present invention will become fully understood from the detailed description given hereinafter in conjunction with the accompanying drawings, in which:

FIG. 1 shows an example of the configuration of a physical computer according to a first embodiment;

FIG. 2 shows an example of virtual computer management data according to the first embodiment;

FIG. 3 shows an example of timer data according to the first embodiment;

FIG. 4 is a flow chart illustrating a time virtualization procedure when a virtual computer is started, according to the first embodiment;

FIG. 5 is a flow chart illustrating a time calculation procedure according to the first embodiment;

FIG. 6 is a flow chart illustrating a timer setting procedure according to the first embodiment; and

FIG. 7 is a flow chart illustrating a time acceleration rate setting procedure according to the first embodiment.

### DESCRIPTION OF EMBODIMENTS

In describing preferred embodiments illustrated in the drawings, specific terminology is employed for the sake of clarity. However, the disclosure of the present invention is not intended to be limited to the specific terminology so selected, and it is to be understood that each specific element includes all technical equivalents that operate in a similar manner and achieve a similar result.

### Embodiment 1

In this embodiment, a description is given of a configuration in which present time in a logical time is calculated based on a counting up cycle of a free-running counter. The free-running counter performs counting up based on a CPU core clock cycle (operation clock cycle) which has a shorter period of time than a timer interrupt cycle.

According to this embodiment, the speed of a logical time can be increased by changing a parameter for calculating the logical time based on the counting up cycle of the free-running counter.

Where a computer is virtualized, a hypervisor (referred to also as virtual computer monitor) shortens a timer interruption period which has been set through timer emulation, according to a time acceleration rate, and issues an interrupt to the virtual computer. Alternatively, an increased value of the free-running counter according to the time acceleration rate is returned.

Machine virtualization includes a full virtualization system in which a hardware (referred to also as H/W) operation is fully emulated, and a paravirtualization system in which a suitable modification for virtualization is made to a guest OS in order to reduce emulation overheads.

In time-related H/W virtualization, a free-running counter and a timer are paravirtualized.

In timer paravirtualization, the hardware itself of a timer is not emulated, but a setting is made to the hypervisor so that the hypervisor calls back a function of a guest OS after a lapse of set time, and a process to be performed upon generation of a timer interrupt is executed in the callback function.

For the free-running timer, the guest OS calculates time in the logical time based on data read out from a physical free-running counter and data transmitted from the hypervisor.

The data transmitted from the hypervisor is composed of a parameter for converting a value of the physical free-running counter into time in the logical time, a free-running counter value as a reference for the calculation of time in the logical time based on the free-running counter, and a parameter of the time corresponding to the free-running counter value.

Where a result from such a time calculation based on a free-running counter value is paravirtualized, however, it is required to change a parameter for converting the value of the free-running counter into time, in order that the speed of the progression of time in the guest OS may be accelerated in the hypervisor.

Simply changing the parameter alone, however, poses a problem of discontinuity in time in the guest OS between a time point right before a change and a time point right after the change, when the time acceleration rate is changed in the progression of the logical time.

In this embodiment, a description is given of a virtual computer system based on a paravirtualization method, performing (1) a method for managing the progression of time in the logical time on a very granular basis, using a free-running counter value; and (2) a method for preventing discontinuity in the progression of time in the logical time when the speed of the logical time is accelerated in the progression of the logical time.

FIG. 1 shows a block diagram of a scheme for controlling the progression of time according to this embodiment.

Referring to FIG. 1, a physical computer 100 includes hardware resources such as a CPU 101, a timer 102, a free-running counter 103 (hereinafter, referred also to simply as counter 103), and a controller 104 for a disk or a network.

The physical computer 100 executes a hypervisor 110, a management virtual computer 120, and virtual computers 130, using those hardware resources.

The physical computer 100 shown in FIG. 1 corresponds to an example of a virtual computer system.

The timer 102 is H/W that generates an interrupt after a lapse of set time, which is described in Non-Patent Document 1, for example.

The free-running counter 103 is a counter that performs counting up continuously at a constant rate, irrespective of the software behavior, which is described in Non-Patent Document 2, for example.

The free-running counter 103, as described earlier, updates the counter value based on the CPU operation clock cycle.

Updating the counter value based on the CPU operation clock cycle includes updating the counter value in synchronization with the CPU operation clock cycle, and updating the counter value at intervals equal to twice, ten times, etc. the length of the CPU operation clock cycle.

The controller 104 is a controller for data exchange over a network such as a LAN (local area network) or with a hard disk device.

A virtual computer 130 is controlled by the hypervisor 110 (also referred to as VM monitor) on the physical computer 100.

A paravirtualized OS 131 is an OS executed on the virtual computer 130, to which a modification (referred to as paravirtualization) has been made to act as a virtual computer.

In paravirtualization, a call to the hypervisor 110 (hypervisor call) is made to implement virtualization.

A time calculation processing section 132 determines time in the logical time in the paravirtualized OS 131.

A timer processing section 133 sets a timer in the paravirtualized OS 131.

Specifically, the timer processing section 133 sets the hypervisor 110 so that the hypervisor 110 calls back a function in the paravirtualized OS 131 after a lapse of time specified by the hypervisor call.

The management virtual computer 120 generates the hypervisor call to the hypervisor 110, manages the generation/deletion of the virtual computers 130, and controls the controller 104 to make an access to a physical disk or a physical network.

A time acceleration rate setting command 121 is a command used by a user to set a time acceleration rate for the virtual computer 130.

A management OS 122 is executed on the management virtual computer 120.

A time acceleration rate setting driver 123 is a driver for transmitting the time acceleration rate transmitted from the time acceleration rate setting command 121, to the hypervisor 110 by the hypervisor call.

The hypervisor 110 manages the virtual computers 130, assigns physical resources such as a CPU and memory, and accepts hypervisor calls.

A time acceleration setting processing section 111 updates data associated with the time of virtual computer management data 140, updates timer data 160, and sets a time acceleration rate 150, based on the time acceleration rate transmitted from the time acceleration rate setting driver 123.

A time virtualization processing section 112 performs a processing for time paravirtualization in the hypervisor 110.

Specifically, the time virtualization processing section 112 is called when the hypervisor 110 starts the virtual computer 130, for example, and sets the data associated with the time of the virtual computer management data 140.

A timer virtualization processing section 113 sets a timer upon receipt of the hypervisor call from the virtual computer 130.

Specifically, the timer virtualization processing section 113 sets the timer 102 and the timer data 160.

A storage unit 105 is hardware in which data and programs are stored. FIG. 1 shows an example of time-related data stored in the storage unit 105.

The virtual computer management data 140 holds data to be used by the hypervisor 110 to manage the virtual computers 130, such as information associated with the CPU and memory used by the virtual computer 130, for example.

The data also includes information for managing time in the virtual computer 130.

The time acceleration rate 150 is data specifying how fast the progression of the logical time is in the virtual computer 130, comparing to the progression of the accrual time.

The time acceleration rate 150 has been set to 1 in advance, where time is not accelerated.

The timer data 160 is managed by the timer virtualization processing section 113 to generate a timer notification to the paravirtualized OS 131.

In this embodiment, a main memory as a RAM (random access memory) and a secondary memory such as a magnetic disk drive, a flash memory, etc. are generically called the storage unit 105.

Program codes for the hypervisor 110, the management virtual computer 120, and the virtual computers 130 are stored in the secondary memory, loaded to the main memory at the time of execution, and read out from the main memory to the CPU 101 for execution, for example.

Parameters, information, data, numerical values, etc. obtained through executions of the hypervisor 110, the management virtual computer 120, and the virtual computers 130 are stored in the storage unit 105 or a register in the CPU 101.

Optionally, the physical computer 100 may include an input/output device, a communication device, and other devices.

In the following discussion, if a statement is made that an element such as the hypervisor 110, the management virtual computer 120, or the virtual computers 130 performs or does something, it is to be understood that the CPU 101 causes the element to perform or does the something.

In other words, if a statement is made that software does some processing, in this specification, it is to be understood that the CPU 101 executes a program to do the processing.

FIG. 2 shows a specific example of the virtual computer management data 140 according to the first embodiment.

The virtual computer management data 140 holds data associated with time management.

Referring to FIG. 2, a time conversion multiplier 141 is used for converting an incremental value of the counter 103 into the logical time.

For example, when the counter 103 performs counting up at a speed of 2 GHz, if the time conversion multiplier 141 is ½, then a conversion is made on the nanosecond time scale.

A reference-time counter value 143 stores a value of the counter 103 at a given timing.

Specifically, the reference-time counter value 143 denotes a counter value of the counter 103 at the moment when reference time 142, described below, is specified. The reference-time counter value 143 corresponds to an example of a reference counter value.

The reference time 142 stores data representing time in the logical time in the virtual computer 130 at the moment when the reference-time counter value 143 is set to a value.

For example, time since the start of the virtual computer 130 is set on the nanosecond time scale.

The reference time 142 is reference time in the logical time which is used for calculating a time in the logical time based on the counter value of the counter 103.

Optionally, the reference time 142 and the reference-time counter value 143 may be set at any timing.

FIG. 3 shows the contents of the timer data 160 according to the first embodiment.

Timer notification times 161 each store time in the actual time corresponding to the time for the timer notification, which is requested by the timer processing section 133 in the paravirtualized OS 131.

Callback functions 162 each are a function in the paravirtualized OS 131 which is called by the hypervisor 110 as the timer notification.

An operation is now discussed.

FIG. 4 is a flow chart illustrating an operation of the time virtualization processing section 112 when the virtual computer 130 is started.

This operation is executed by the hypervisor 110 when starting each virtual computer 130.

In S401, the time virtualization processing section 112 executes processings of S402 and the subsequent steps to the virtual computer management data 140 corresponding to the virtual computers 130 which is to be started.

In S402, the time virtualization processing section 112 sets the time conversion multiplier 141.

Specifically, the time virtualization processing section 112 sets a product of the time acceleration rate 150 and a time conversion multiplier value for non-time acceleration, which has previously been obtained as the time conversion multiplier 140.

It is to be noted that for the management virtual computer 120, the time acceleration rate is always set to 1 for calculation.

The time conversion multiplier 141 is a value for calculating time in the logical time based on the counter value. The time conversion multiplier 141 corresponds to an example of a coefficient value.

In S403, the time virtualization processing section 112 sets the reference time 142 to reference time (in the logical time) in virtual-computer time calculation.

Specifically, the reference time denotes a value that represents, on the nanosecond time scale, time since a virtual computer is started, or since a special date, both of which are set to 0, until the present time, for example.

In S404, the time virtualization processing section 112 sets the counter value of the counter 103 at the point in time when the reference time 142 has been set, as the reference-time counter value 143.

FIG. 5 is a flow chart illustrating an operation of the time calculation processing section 132 for calculating time in the paravirtualized OS 131.

In S501, the time calculation processing section 132 is called by a system call requesting the present time from an application program, or the like.

In S502, the time calculation processing section 132 reads out a current counter 103 value; and the time conversion multiplier 141, the reference time 142, and the reference-time counter value 143 in the management data 140 of the virtual computer.

In S503, the time calculation processing section 132 subtracts the reference-time counter value 143 from the current counter 103 value read out at 5502, multiplies the subtraction value by the time conversion multiplier 141, adds the resultant product to the reference time 142, and returns the obtained result to the calling end as the present time in the logical time.

FIG. 6 is a flow chart illustrating an operation of the timer processing section 133 for setting a timer hi the paravirtualized OS 131.

In S601, an application program sets the timer using a system call, or a processing in the paravirtualized OS 131 sets the timer, then the timer processing section 133 is called.

In S602, the timer processing section 133 generates the hypervisor call to the hypervisor 110 and specifies calling timing of the callback function.

Specifically, the timer processing section 133 sets the hypervisor so that the hypervisor calls a specified function after a lapse of specified time.

More specifically, the timer processing section 133 specifies the calling timing of the callback function by time in the logical time.

In S603, the timer virtualization processing section 113 is called by the hypervisor call, then calculates time in the actual time after a lapse of the time specified by the time processing section 133, sets the time as timer notification time 161 in the timer data 160, and sets the callback function 162 to the callback function specified by the timer processing section 133.

For the calculation of the timer notification time, the lapse time received at S602 is divided by the time acceleration rate 150 in advance.

It is to be noted that for the management virtual computer 120, the time acceleration rate is always set to 1 for calculation.

In S604, the timer virtualization processing section 113 selects from among the timer notification times 161, one having the nearest time in the future for notification, and sets the timer 102 to generate an interrupt at that selected time.

In S605, upon receipt of an interrupt from the timer 102 at the set time at 5604, the timer virtualization processing section 113 selects from among the time notification times 161 in the timer data 160, those before the present time, and then calls up callback functions 162 corresponding to the selected.

In S606, the timer virtualization processing section 113 deletes the entries of timer notification times 161 and callback functions 162 that have been processed at S605.

FIG. 7 is a flow chart illustrating an operation when the time acceleration rate is changed.

In S701, a user sets the changed time acceleration rate as a change request of the time acceleration rate, using the time acceleration setting command 121.

In S702, the time acceleration rate setting command 121 issues the system call to the management OS 122, and notifies the changed time acceleration rate to the time acceleration rate setting driver 123 in the management OS 122.

In S703, the time acceleration rate setting drive 123 issues the hypervisor call to the hypervisor 110, and notifies the changed time acceleration rate to the time acceleration setting processing section 111.

In S704, the time acceleration setting processing section 111 subtracts the value of the reference-time counter value 143 from the current counter 103 value, multiplies the resultant subtraction value by the value of the time conversion multiplier 141, adds the resultant product to the reference time 142, and sets the obtained value as new reference time 142, for the virtual computer management data 140.

Then, the reference-time counter value 143 is set to the current counter 103 value.

In S705, the time acceleration setting processing section 111 sets a product of the value of the time conversion multiplier for non-time acceleration and the time acceleration rate 150 received at S703, as a new value of the time conversion multiplier 141, for the virtual computer management data 140.

It is to be noted that for the management virtual computer 120, the time acceleration rate is always set to 1 for calculation.

In 706, the time acceleration setting processing section 111 subtracts the present time in the actual time from each timer notification time 161, multiplies the resultant subtraction value by the time acceleration rate 150 before the change (obtaining a remaining time in the logical time), divides the resultant product by the time acceleration rate received at S703 (conversion into the actual time), adds the resultant quotient to the present time (actual time), and sets the resultant addition value as new timer notification time 161.

It is to be noted that for the management virtual computer 120, the time acceleration rate is always set to 1 for calculation.

In S707, the time acceleration setting processing section 111 sets the time acceleration rate 150 to the value received at 5703, for the virtual computer management data 140.

After the storage unit 105 stores the reference time 142 and the reference-time counter value 143 set at S704, the time conversion multiplier 141 set at S705, and the value of the time acceleration rate 150 set at S707, when the procedure shown in FIG. 5 is performed, the reference time 142 and the reference-time counter value 143 set at S704, and the time conversion multiplier 141 set at S705 are used.

As discussed above, when the time acceleration rate is changed, the reference time as a parameter used for calculating time used by the paravirtualization OS, and the counter value at that moment are updated, the time conversion multiplier is updated according to the time acceleration rate, and the timer notification time of the timer data is updated according to the time acceleration rate. Therefore, if the time acceleration rate is changed while the virtual computer is running, the change does not cause any trouble in the progression of time in the paravirtualized OS.

Further, the above mentioned operation can be performed without change of the OS on each virtual computer.

Further, time in two or more virtual computers running on a physical computer can be accelerated simultaneously.

Further, since the virtual computer for management can be excluded from the time acceleration, the timeout control of physical I/O cannot be affected by the time acceleration.

As discussed, the virtual computer system based on the paravirtualization method of this embodiment includes:

(a) a section for setting the acceleration rate of the progression of time in the paravirtualized OS, from the virtual computer for management;
(b) a section for accelerating the progression of time in the paravirtualized OS, in the hypervisor; and
(c) a section for accelerating the timer processing of the paravirtualized OS, in the hypervisor.

With respect to (b) “a section for accelerating the progression of time in the paravirtualized OS, in the hypervisor”, in the time acceleration setting procedure performed in the hypervisor, the parameter used for calculating time to be transmitted to the paravirtualized OS is updated according to the time acceleration rate at the moment when the time acceleration rate is changed, as discussed above.

With respect to the update of parameters to be used for time calculation, the time acceleration rate is not reflected on the virtual computer for management, as also discussed earlier.

With respect to (c) “a section for accelerating the timer processing of the paravirtualized OS”, in the time acceleration setting procedure performed in the hypervisor, the data of the timer managed by the hypervisor is updated according to the time acceleration rate, as discussed above.

With respect to the update of the data of the timer, the time acceleration rate is not reflected on the virtual computer for management, as discussed above.

With respect to (a) “a section for setting the acceleration rate of the progression of time”, the command in the virtual computer for management specifies the acceleration rate to the driver of the management OS. The driver of the management OS then generates the hypervisor call and specifies the acceleration rate to the time acceleration setting procedure performed in the hypervisor, as discussed above.

Optionally, the functions and processes described in this embodiment may be executed only partially.

It is to be noted that the present invention is not limited to this embodiment. This embodiment may be modified in many ways where appropriate.

Numerous additional modifications and variations are possible in light of the above teachings. It is therefore to be understood that, within the scope of the appended claims, the disclosure of this patent specification may be practiced otherwise than as specifically described herein.

### REFERENCE SIGNS LIST

100 physical computer
101 CPU
102 timer
103 counter
104 controller
105 storage unit
110 hypervisor
111 time acceleration setting processing section
112 time virtualization processing section
113 timer virtualization processing section
120 management virtual computer
121 time acceleration rate setting command
122 management OS
123 time acceleration rate setting driver
130 virtual computer
131 paravirtualized OS
132 time calculation processing section
133 timer processing section
140 virtual computer management data
150 time acceleration rate
160 timer data

1. A virtual computer system based on a paravirtualization method, comprising:
a paravirtualized OS (operating system) which has been paravirtualized;
a hypervisor, and
hardware resources including:
a CPU (central processing unit) for executing the paravirtualized OS and the hypervisor;
a storage unit; and
a free-running counter for updating a counter value based on an operation clock cycle of the CPU,
wherein:
the hypervisor is executed by the CPU to:
specify reference time in an actual time, as reference time, to be used for calculating time in a logical time based on the counter value, the logical time having a different speed in the progression of time from the actual time;
specify a reference counter value, which is the counter value at the moment when the reference time is specified; and
specify a coefficient value for calculating the time in the logical time, based on the counter value;
the storage unit stores the reference time, the reference counter value, and the coefficient value: and
the paravirtualized OS is executed by the CPU to:
read out the reference time, the reference counter value, and the coefficient value from the storage unit;
read out a current counter value from the free-running counter; and
calculate present time in the logical time based on the reference time, the reference counter value, the coefficient value, and the current counter value; and
the hypervisor, when the virtual computer system has received a change request requesting a change in the coefficient value:
reads out the reference time, the reference counter value, and the coefficient value from the storage unit;
reads out the current counter value from the free-running counter;
subtracts the reference counter value from the current counter value, multiplies a resultant subtraction value by the coefficient value before the change, adds a resultant product to the reference time, and specifies a resultant addition value as new reference time,
specifies the current counter value as new reference counter value; and
specifies a changed coefficient value as a new coefficient value;
the storage unit stores the new reference time, the new reference counter value, and the new coefficient value; and
the paravirtualized OS, after the virtual computer system has received the change request of the coefficient value:
reads out the new reference time, the new reference counter value, and the new coefficient value from the storage unit;
reads out the current counter value from the free-running counter; and
calculates the present time in the logical time based on the new reference time, the new reference counter value, the new coefficient value, and the current counter value.

2. The virtual computer system of claim 1, further comprising:
a timer as a hardware resource,
wherein:
the paravirtualized OS:
specifies a function in the paravirtualized OS, as a callback function, to be called up by the hypervisor; and
specifies calling timing of the callback function, in the logical time; and
the hypervisor:
calculates time in the actual time, as timer notification time, corresponding to the calling timing specified by the paravirtualized OS based on the coefficient value;
sets the timer to the timer notification time so that a notification is made from the timer when the timer notification time comes, and
calls up the callback function specified by the paravirtualized OS when the notification is made from the timer.

3. The virtual computer system of claim 2, wherein the hypervisor divides time in the logical time until the calling timing by the coefficient value, adds a resultant quotient to present time in the actual time, and sets a resultant addition value as the timer notification time.

4. The virtual computer system of claim 3,
wherein:
the hypervisor, when the virtual computer system has received the change request requesting the change of the coefficient value after the timer is set to the timer notification time and before the notification comes from the timer:
reads out the coefficient value from the storage unit;
subtracts the present time in the actual time from the timer notification time, multiplies a resultant subtraction value by the coefficient value before the change, divides a resultant product by the changed coefficient value, adds a resultant quotient to the present time in the actual time, and specifies a resultant addition value as new timer notification time;
sets the timer to the new timer notification time so that the notification is made from the timer when the new timer notification time comes, and
calls up the callback function specified by the paravirtualized OS when the notification is made from the timer.

5. The virtual computer system of claim 1, comprising:
a management OS executed by the CPU to manage the paravirtualized OS;
wherein:
when the virtual computer system has received the change request,
the hypervisor causes the management OS not to be reflected by the new coefficient value.

6. The virtual computer system of claim 4, comprising:
a management OS executed by the CPU to manage the paravirtualized OS;
wherein:
when the virtual computer system has received the change request, and the timer is set to the timer notification time for calling up the function in the management OS,
the hypervisor neither calculates nor sets the new timer notification time for the function in the management OS.

7. The virtual computer system of claim 5, wherein the management OS issues the hypervisor call to notify the hypervisor of the change request of the coefficient value.
